(19) United States
(12) Patent Application Publication
(10) Pub. No.: US 2025/0158158 A1
(43) Pub. Date: May 15, 2025

(54) MODULE BATTERY COOLING SYSTEM

(71) Applicant: RASCO d.o.o., Kalinovac (HR)

(72) Inventor: Ivan Franicevic, Djurdjevac (HR)

(21) Appl. No.: 18/509,040

(22) Filed: Nov. 14, 2023

(51) Int. Cl. H01M 10/6556; H01M 10/613; H01M 10/643; H01M 10/653; H01M 10/658; H01M 50/213; H01M 50/224; H01M 50/233

(52) U.S. Cl. CPC H01M 10/6556; H01M 10/613; H01M 10/643; H01M 10/653; H01M 10/658; H01M 50/213; H01M 50/224; H01M 50/233

(57) ABSTRACT

A battery module cooling system features two cooling plates: one on the top and one on the bottom of a battery cell array. Each plate has fluid inlet and outlet channels that supply and receive fluid from various sets of channels. These channels are designed so that the hottest portion of one channel is adjacent to the coolest portion of another, promoting efficient heat distribution. In addition, the hottest part of the top plate's channel and the coolest part of the bottom plate's channel are both thermally connected to the same subset of battery cells.

### BACKGROUND

### Technical Field

This disclosure relates generally to battery module structures, and more specifically to energy-dense modular battery module structures with cooling systems.

### Description of Related Art

In recent years, electric vehicles (EVs) have undergone substantial technological growth. An EV includes at least one electric motor and one or more battery packs. These battery packs, often the priciest part of an EV, serve as energy storage, much like a fuel tank in conventional vehicles. The range or duration an EV can operate on a single charge depends on the battery's capacity, making it a crucial consideration for both everyday users and commercial applications. Moreover, the design and efficiency of the battery can shape an EV's acceleration, peak speed, and overall functioning. For high-performance EVs, battery cells that can supply vast power swiftly are essential. The battery's size and weight also play a pivotal role in influencing the vehicle's design, maneuverability, and efficiency. Therefore, enhancing energy density while minimizing weight and size is an important objective in battery technology.

Further, beyond consumer electric cars, the EV category encompasses a diverse range of vehicles such as bicycles, scooters, motorcycles, airplanes, ships, industrial machinery, golf carts, skateboards, wheelchairs, and drones. Each type of EV, with its unique form and power demands, often requires the design of a specialized battery pack. This task is highly technical and complex and often comes with significant costs.

### SUMMARY

Embodiments described herein relate to an energy-dense battery module. The battery module includes an array of battery cells that are organized such that their top and bottom surfaces are parallel. Surrounding these cells is a non-conductive shell. Both the top and bottom surfaces of the battery cells are in contact with distinct non-conductive layers, each having openings aligned with each battery cell. Electrical connections are made to the top and bottom surfaces through these openings using two sets of leads. To manage heat, thermally conductive, compressible material may be used, e.g., thermally conductive beads may be aligned with the top and bottom surfaces of the cells. The module incorporates two thermally conductive plates on its outermost top and bottom surfaces. These plates, equipped with interior fluid channels for heat dissipation, compress the aforementioned beads into the battery cells, aiding in thermal management.

The battery module is not only energy dense, but also highly modular. In particular, each battery module can include any number of battery cells arranged in parallel, series, or a combination of both. Moreover, this battery module can be linked with one or multiple other battery modules either in parallel, series, or a combination of both. The modularity of the embodiments described herein allows EV designers to configure a battery pack as per their voltage and capacity requirements by arranging modules in series, parallel, or a combination of both and to fit specific spatial or capacity requirements.

Embodiments described herein also relate to a battery module cooling system. The battery module cooling system includes two cooling plates: one thermally linked to the top surface and another to the bottom surface of a battery cell array. Each cooling plate includes a fluid inlet, an outlet, and channels connecting the inlet and outlet. The first cooling plate's inlet feeds multiple sets of fluid channels, which subsequently drain into the outlet channel. In particular, these channels are arranged so the hottest part of one channel is next to the coolest part of another, enhancing thermal distribution across the cooling plate. The second cooling plate mirrors this design. Further, the configuration of the first cooling plate and the second cooling plate is such that the hottest segment of the first cooling plate's fluid channel and the coolest segment of the second plate's fluid channel are both thermally connected to the same group of battery cells, further enhancing thermal distribution across the module.

### BRIEF DESCRIPTION OF THE DRAWINGS

FIG. 1 illustrates an example embodiment of a battery module in accordance with one or more embodiments.

FIG. 2A illustrates a perspective view of the battery module of FIG. 1 with the cooling plates removed in accordance with one or more embodiments.

FIG. 2B illustrates an exploded view of a battery module with the cooling plates removed in accordance with one or more embodiments.

FIG. 2C illustrates an example arrangement of the battery cells in accordance with one or more embodiments.

FIG. 2D illustrates an enlarged view of a portion of the busbars in accordance with one or more embodiments.

FIG. 2E illustrates an enlarged view of a portion of non-conductive layers in accordance with one or more embodiments.

FIG. 2F illustrates a relationship between the battery cells and the busbars in accordance with one or more embodiments.

FIG. 3 illustrates an example circuit diagram representing the connections of the battery cells in the battery module.

FIG. 4 illustrates an example battery pack including 16 battery modules connected to each other in series.

FIG. 5 illustrates an example circuit diagram representing the connections of the multiple battery modules in a battery pack of FIG. 4 in accordance with one or more embodiments.

FIG. 6 illustrates an example embodiment of a cooling plate.

FIG. 7 illustrates an example embodiment of a cooling plate including a top layer and a bottom layer (also referred to as a first layer and a second layer).

FIG. 8 illustrates a cross-sectional view of a portion of the battery module in accordance with one or more embodiments.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

In recent years, electric vehicles (EVs) have undergone substantial technological growth. Beyond consumer electric cars, the EV category encompasses a diverse range of vehicles, such as bicycles, scooters, motorcycles, airplanes, ships, industrial machinery, golf carts, skateboards, wheelchairs, and drones. Many small to medium-sized vehicle manufacturers are transitioning from internal combustion engines to EVs. However, each type of EV, with its unique form and power demands, often requires the design of a specialized battery pack. This task is highly technical and complex, and often comes with significant costs.

Further, the battery's size and weight play a pivotal role in influencing the vehicle's design, maneuverability, and efficiency. Therefore, enhancing energy density while minimizing weight and size is an important objective in battery technology.

### Battery Module Overview

The embodiments described herein relate to energy-dense modular battery structures that solve the above-described problem. The battery modules described herein are highly variable and flexible, allowing adjustments in size, type of cells, voltage power, and placement orientation to suit the diverse requirements of a broad range of EVs.

The modularity of the embodiments described herein allows EV designers to configure a battery pack as per their voltage and capacity requirements by arranging modules in series, parallel, or a combination of both and to fit specific spatial or capacity requirements. Further, if one module fails, it can be replaced without having to replace the entire battery pack. This can lead to cost savings and reduced downtime. In addition, in case of a malfunction or damage to a specific module, the affected module can be isolated and removed. This also limits the spread of potential issues to other modules or components. In some embodiments, individual modules can be charged separately based on their state of charge, which can lead to faster and more efficient charging overall. Further, since each module has its own cooling plates, heat is more evenly distributed, reducing the risk of overheating and potentially extending the battery's lifespan.

The battery module includes a set of battery cells organized in an array such that top surfaces of the battery cells are substantially coplanar, and bottom surfaces of the battery cells are substantially coplanar. The battery module also includes a non-conductive shell abutting a perimeter of the set of battery cells.

The battery module also includes a first non-conductive layer abutting the top surfaces of the battery cells, and a second non-conductive layer abutting the bottom surfaces of the battery cells. The first non-conductive layer includes, for each battery cell, an opening aligned with the top surface of the battery cell. The second non-conductive layer includes, for each battery cell, an opening aligned with the bottom surface of the battery cell.

The battery module also includes a first set of leads electrically coupling to the top surfaces of the battery cells through the openings of the first non-conductive layers, and a second set of leads electrically coupling to the bottom surfaces of the battery cells through the openings of the second non-conductive layers. The battery module also includes a first set of thermally conductive, compressible beads aligned with the top surfaces of the battery cells, and a second set of thermally conductive, compressible beads aligned with the bottom surface of the battery cells.

The battery module also includes a first thermally conductive plate and a second thermally conductive plate, each comprising interior fluid channels for heat dissipation. The first thermally conductive plate forms an outside top surface of the battery module and compresses the first set of thermally conductive compressible beads into the top surfaces of the battery cells through the openings of the first non-conductive layer. The second thermally conductive plate forms an outside bottom surface of the battery module, and compresses the second set of thermally conductive, compressible beads into the bottom surfaces of the battery cells through the openings of the second non-conductive layer.

The battery modules described herein can achieve more than 400 watt-hours per liter at the module level and more than 350 watt-hours per liter at the pack level. Further, they also can achieve approximately 208 watt-hours per kilogram. Accordingly, in terms of energy density, design, and production costs, the performance of the battery modules described herein surpasses many existing battery modules. Additionally, these modules are self-reliant, durable, and integrate smoothly with each other.

### Cooling System Overview

The embodiments described herein also relate to a battery module cooling system. A cooling system of a battery module is crucial for normal operation of the battery module. Battery cells operate best with a specific temperature range. If a battery becomes too hot, its performance can be compromised, which may result in reduced acceleration, power, and/or range of an EV, or even the inability of the battery module to deliver power. Further, prolonged exposure to high temperatures can cause damage to the battery cells, leading to reduced capacity and thus decreasing the range of an EV over time. By maintaining the battery within its optimal temperature range, the cooling system can help prolong the battery's lifespan. Further, when the battery module becomes more energy-dense, it can also generate more heat. Efficient cooling systems are needed to manage the battery module.

Existing cooling systems of battery packs are often placed on the sides of the battery cells. For example, some existing cooling systems include a serpentine cooling channel that weaves around the cylindrical battery cells to extract heat. Although it is intuitive to extract heat from the sides of battery cells, such a cooling system presents manufacturing challenges. Further, it is potentially more prone to defects or inconsistencies due to its complexity.

Unlike such an existing cooling system that extracts heat from the sides of battery cells, the embodiments described herein relate to a novel and improved cooling system configured to extract heat from top and bottom surfaces of battery cells.

The battery module cooling system includes a first cooling plate thermally coupled to a top surface of an array of battery cells, and a second cooling plate thermally coupled to a bottom surface of an array of battery cells.

The first cooling plate includes a first fluid inlet channel and a first fluid outlet channel. The first fluid inlet channel feeds each of a first plurality of sets of fluid channels that each feed the first fluid outlet channel. The first plurality of sets of fluid channels are arranged such that a hottest portion of a first fluid channel is adjacent to a coolest portion of a second fluid channel, ensuring efficient heat exchange across the first cooling plate.

Similarly, the second cooling plate includes a second fluid inlet channel and a second fluid outlet channel. The second fluid inlet channel feeds each of a second plurality of sets of fluid channels that each feed the second fluid outlet channel. The second plurality of sets of fluid channels are arranged such that a hottest portion of a third fluid channel is adjacent to a coolest portion of a fourth fluid channel, ensuring efficient heat exchange across the second cooling plate.

Further, the hottest portion of the first fluid channel of the first cooling plate and the coolest portion of the fourth fluid channel of the second cooling plate are thermally coupled to a same subset of battery cells, ensuring efficient temperature management across the module.

### Battery Module Architecture

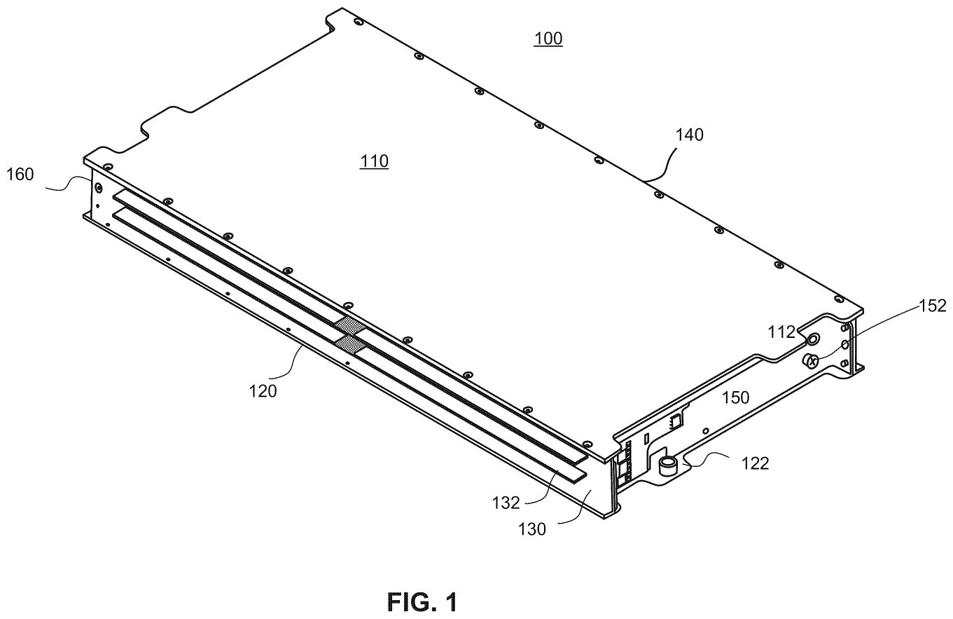

FIG. 1 illustrates an example embodiment of a battery module 100 in accordance with one or more embodiments. The battery module 100 includes a set of battery cells (not shown), two thermally conductive plates 110, 120 (forming top and bottom surfaces), two carrier sheets 130, 140 (forming side surfaces) and two carrier sheets 150, 160 (forming front and rear surfaces). The conductive plates 110, 120, and the carrier sheets 130, 140, 150, and 160 are configured to house and support the set of battery cells. Note, the terms “front,” “rear,” “top,” “bottom,” and “side” are used for clarity and ease of description. The battery module 100 can be flipped over, causing the top side to become the bottom side and vice versa. In some embodiments, the battery module 100 can also be positioned vertically on one of its side surfaces.

The battery module 100 also includes a positive potential terminal 152 on the front surface and a negative potential terminal (not shown) on the back surface. In some embodiments, the positive potential terminal 152 and the negative potential terminal are placed at opposing sides (e.g., front and rear side) of the battery module 100.

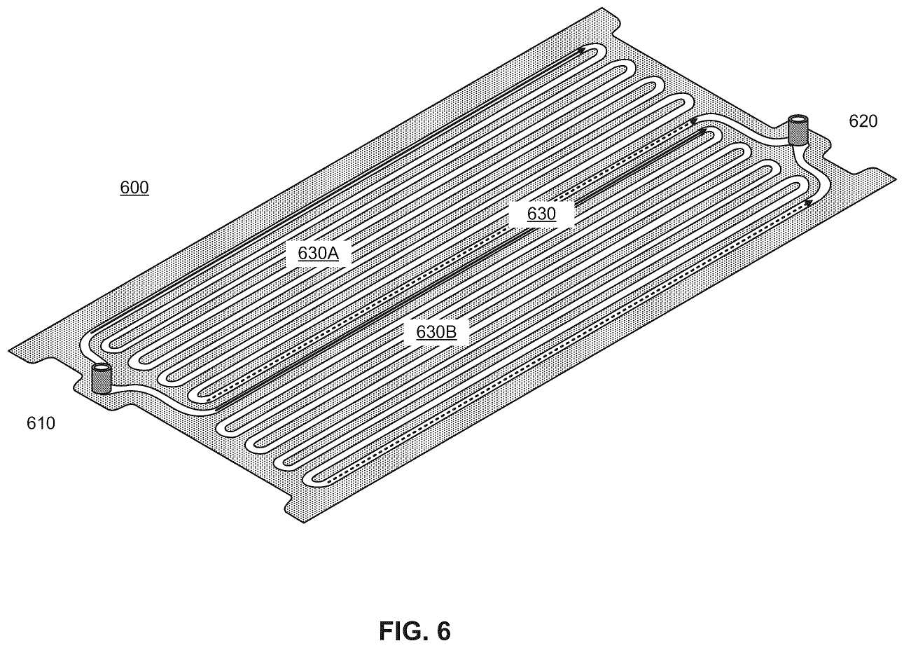

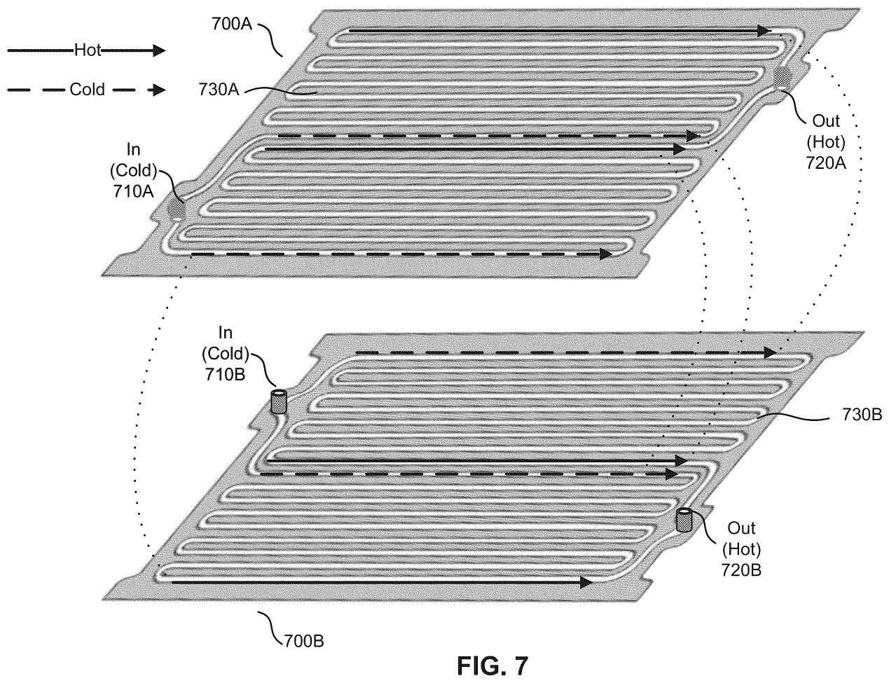

Notably, the first thermally conductive plate 110 and the second thermally conductive plate 120 serve a dual purpose. They not only help in heat dissipation from battery cells, but also act as structural support, forming the external top and bottom surfaces of the battery module 100. Each of the thermally conductive plates 110 and 120 (also referred to as “cooling plates”) includes an inlet 112, 122 at the front side, an outlet (not shown) at the back side, and interior fluid channels (not shown) connecting the inlets and outsets for heat dissipation. Note, in some embodiments, the inlets and outlets are interchangeable. Thus, inlets can function as outlets and vice versa. Additional details about the thermally conductive plates 110, and 120 are further discussed below with respect to FIGS. 6-7.

Further, in addition to the thermally conducted plates on top and bottom of the battery module 100, the battery module 100 also includes four side surfaces 130, 140, 150, 160 (referred to as sides, front, and rear surfaces). In some embodiments, each of the front, rear, and side surfaces is formed from a metal sheet, such as aluminum.

In some embodiments, each of the side surfaces 130, 140 further includes one or more lateral carriers 132, extruding from the side surfaces 130, 140 of the battery module 100. In some embodiments, the carriers 312 also serve a dual purpose. They not only provide additional structural support for the battery module 100, but also enable the connection of multiple modules into a pack. In some embodiments, there are two or more lateral carriers 312 on each of the two sides of the battery module. In some embodiments, the lateral carriers 312 are metal bars, such as aluminum bars.

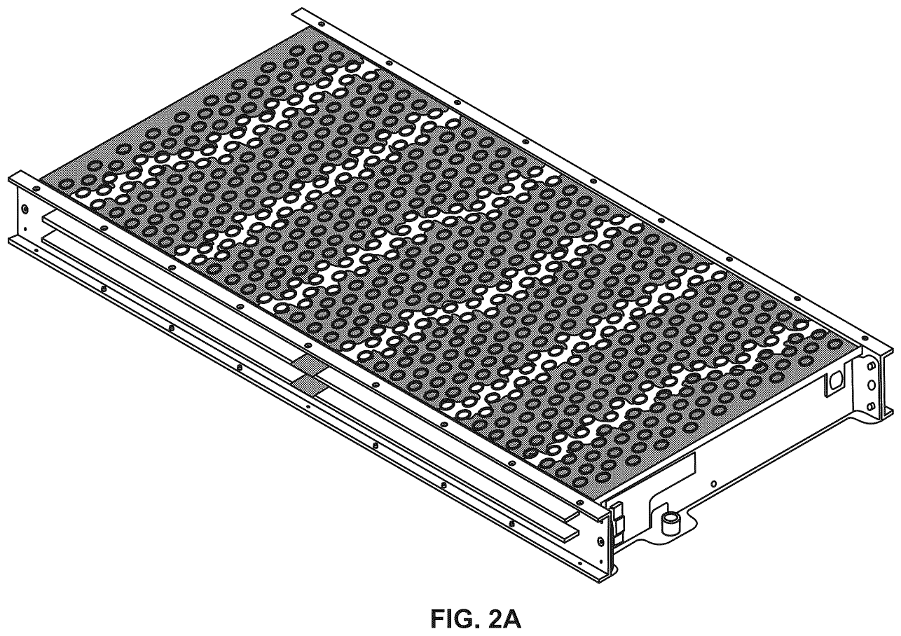

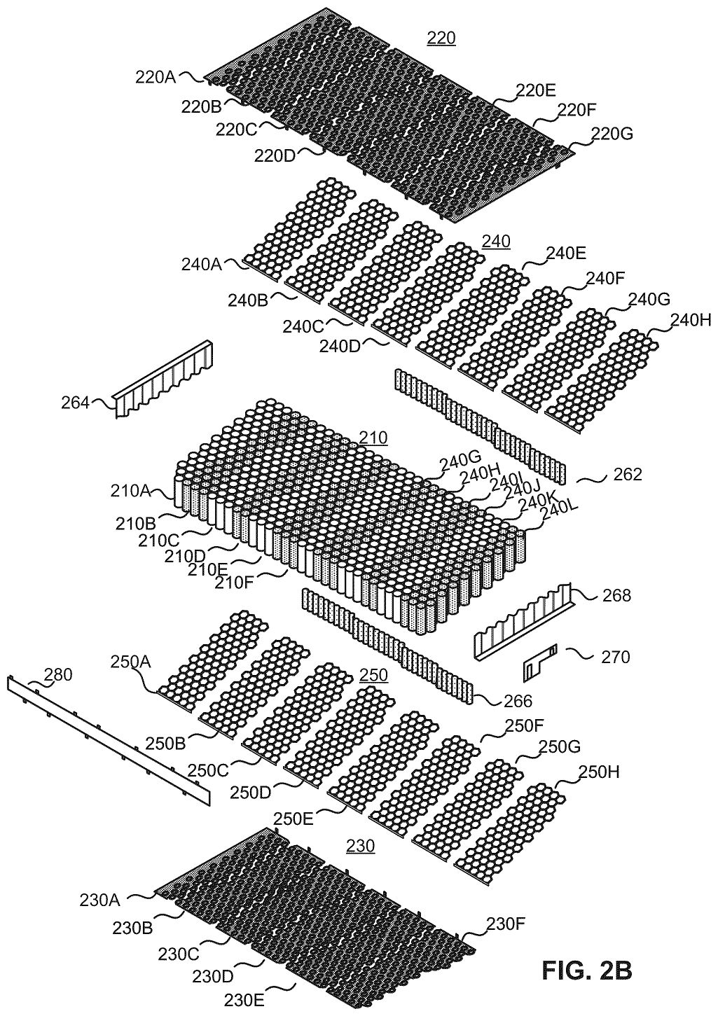

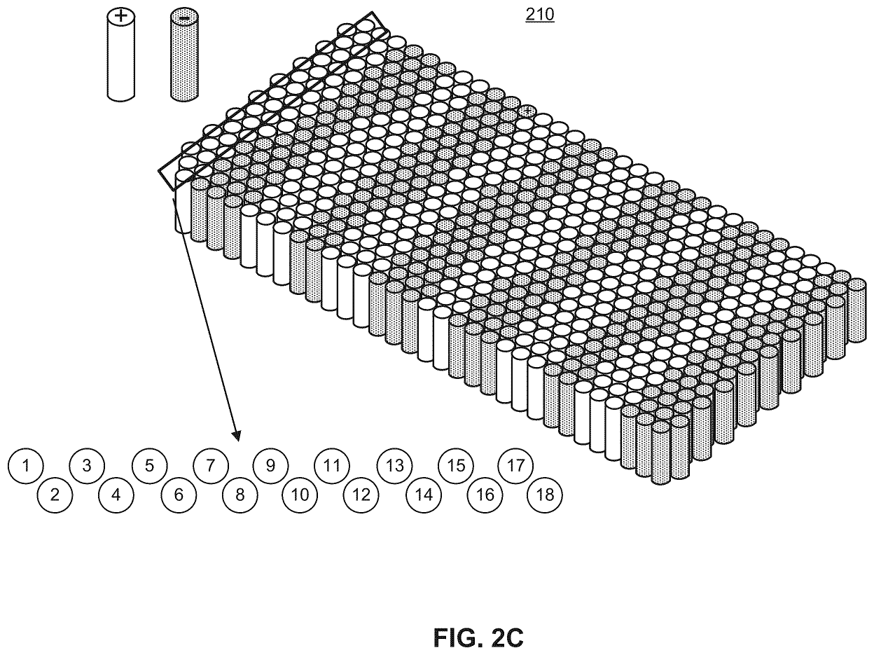

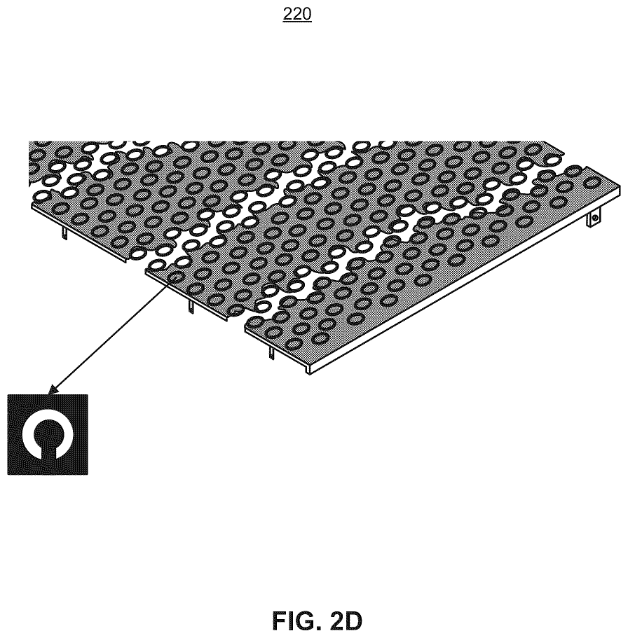

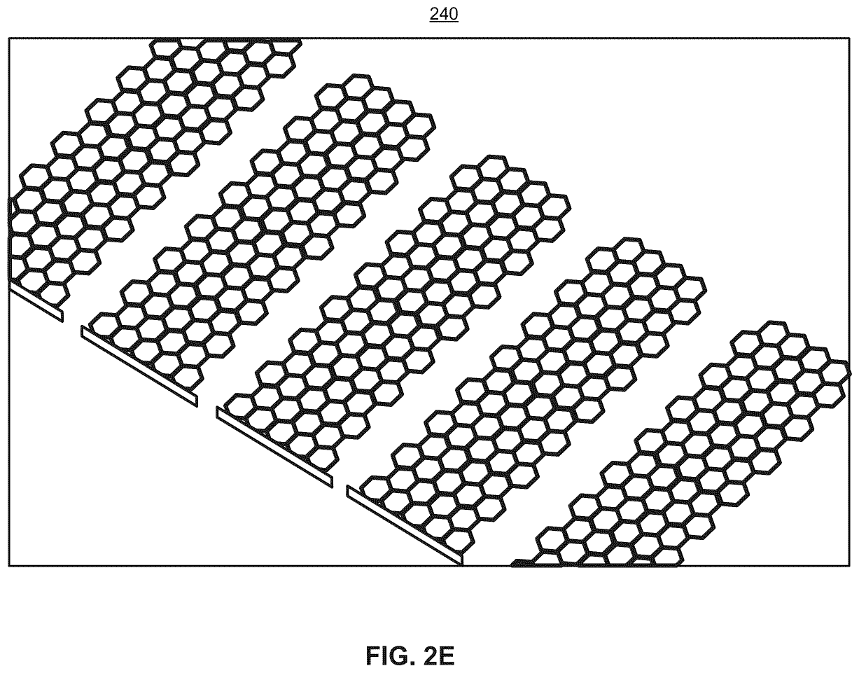

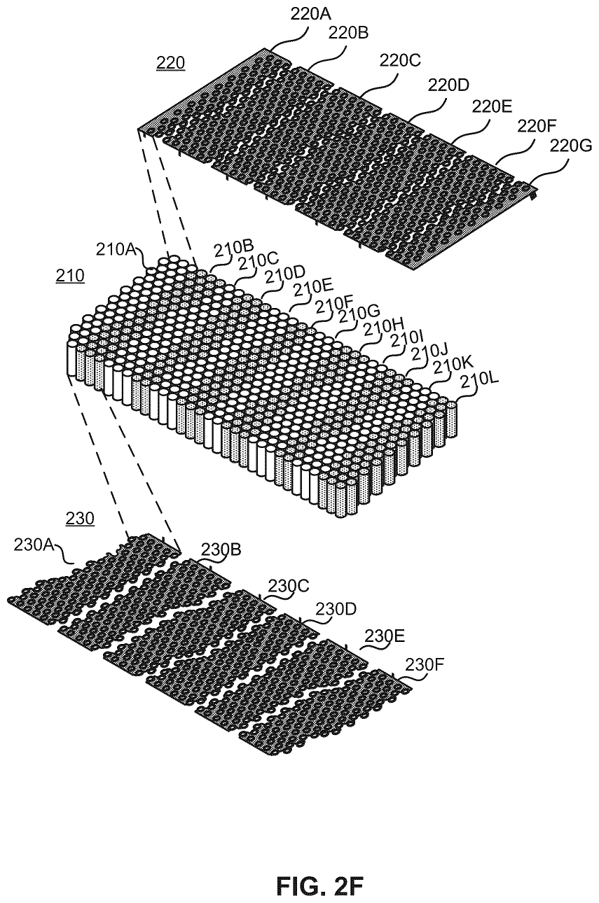

FIG. 2A illustrates a perspective view of the battery module 100 of FIG. 1 with a top cooling plate removed in accordance with one or more embodiments. FIG. 2B illustrates an exploded view of a battery module 100 of FIG. 1 with both cooling plates removed in accordance with one or more embodiments. As illustrated in FIGS. 2A and 2B, the battery module 100 includes a set of battery cells 210, multiple busbars 220, 230, multiple non-conductive layers 240, 250, multiple holders 262, 264, 266, 268 for each side, a slave battery management system (BMS) 270, and a printed circuit board (PCB) 280. In some embodiments, the PCB 280 is a flexible PCB.

The battery module 100 also includes a master BMS (not shown) placed inside the battery pack and connected to the slave BMS 270 via wired or wireless connections. The slave BMS 270, master BMS and the PCB 280 are responsible for cell balancing and voltage and temperature measurements. As cells in a battery module age, they can develop differences in state of charge. Cell balancing ensures that all cells in a pack are kept at a similar state of charge, which improves the longevity and performance of the pack. Voltage measurement includes monitoring the voltage of individual cells or groups of cells to prevent them from overcharging or discharging beyond safe limits. Temperature measurement includes monitoring the temperature of cells. Battery cells can be dangerous if they get too hot, so temperature monitoring is important. The master BMS may determine if balancing should be performed, or if the entire battery pack should be derated, shut down, or any other actions should be taken. For example, responsive to determining, by the master BMS, that the temperature is greater than a threshold, the slave BMS 270 is configured to take action, such as reducing charge or discharge rates.

A first non-conductive layer 240 abuts the top surfaces of the battery cells, and a second non-conductive layer 250 abuts the bottom surfaces of the battery cells. The first non-conductive layer 240 includes, for each battery cell, an opening aligned with the top surface of the battery cell. The second non-conductive layer 250 includes, for each battery cell, an opening aligned with the bottom surface of the battery cell.

The busbars 220, 230 also include multiple openings, each of which corresponds to a lead. Each lead is coupled to an edge of a corresponding opening and at least partially suspended within the corresponding opening. Each lead corresponds to a top surface or a bottom surface of a battery cell. A first set of leads (coupled to one or more first busbar 230) are electrically coupled to the top surfaces of the battery cells through the openings of the first non-conductive layers, and a second set of leads (coupled to one or more second busbars 230) are electrically coupled to the bottom surfaces of the battery cells through the openings of the second non-conductive layers. Each of the first busbars or second busbars are electrically isolated from each other, they also can have different shapes to enable different configurations of the battery cells.

In some embodiments, the set of battery cells 210 includes multiple subsets of battery cells. Each subset includes a predetermined number of adjacent battery cells. The multiple subsets of battery cells include a first subset 210A of battery cells and a second subset 210B of battery cells. The first subset 210A of battery cells and the second subset 210B of battery cells are arranged in opposite directions, such that positive potential terminals of the first subset 210A of battery cells correspond to top surfaces of the first subset 210A of battery cells, and negative potential terminals of the first subset 210A of battery cells correspond to bottom surfaces of the first subset 210A of battery cells, while positive potential terminals of the second subset 210B of battery cells correspond to bottom surfaces of the second subset 210B of battery cells, and negative potential terminals of the second subset 210B of battery cells correspond to top surfaces of the second subset 210B of battery cells.

In some embodiments, the first non-conductive layer 240 includes a first separation portion 240A abutting top surfaces of the first subset 210A of battery cells, and a second separation portion 240B abutting top surfaces of the second subset 210B of battery cells. The second non-conductive layer 250 includes a third separation portion 250A abutting bottom surfaces of the first subset 210A of battery cells, and a fourth separation portion 250B abutting bottom surfaces of the second subset 210B of battery cells. There may be any number of separation portions abutting top or bottom surfaces of any number of subset of battery cells.

In some embodiments, one or more first busbars 220 (at top) include a first set of leads electrically coupling to the top surfaces of the battery cells 210 through the openings of the first non-conductive layer 240, and one or more second busbars 230 (at bottom) include a second set of leads electrically coupling to the bottom surfaces of the battery cells 210 through the openings of the second non-conductive layer 250.

The first set of leads (coupled to the one or more first busbar 220 at top) include a first subset of leads 220A, each of which is electrically coupled to one of the positive terminals of the first subset 210A of battery cells. The second set of leads (coupled to the one or more second busbars 230 at bottom) include a second subset 230A of leads, each of which is electrically coupled to one of the negative terminals of the first subset 210A of battery cells. Further, the first subset 220A of the leads are electrically coupled to each other (via the first busbar 220), and the second subset of leads 230A are electrically coupled to each other (via the second busbar 230), causing the first subset of battery cells to be electrically connected to each other in parallel.

In some embodiments, the first set of leads (coupled to the one or more first busbars 220 at top) further include a third subset 220B of leads, each of which is electrically coupled to one of the negative terminals of the second subset 210B of battery cells, and the second set of leads (coupled to the one or more second busbars 230 at bottom) further include a fourth subset 230B of leads, each of which is electrically coupled to one of the positive terminals of the second subset 210B of battery cells. The third subset 220B of leads are electrically coupled to each other, and the fourth subset 230B of leads are electrically coupled to each other, causing the second subset 210B of battery cells to be electrically connected to each other in parallel.

In some embodiments, the second subset 230A of leads and the fourth subset 230B of leads are also electrically coupled to each other (via a second busbar 230), causing the first subset 210A of battery cells and the second subset 210B of battery cells to be electrically connected to each other in series.

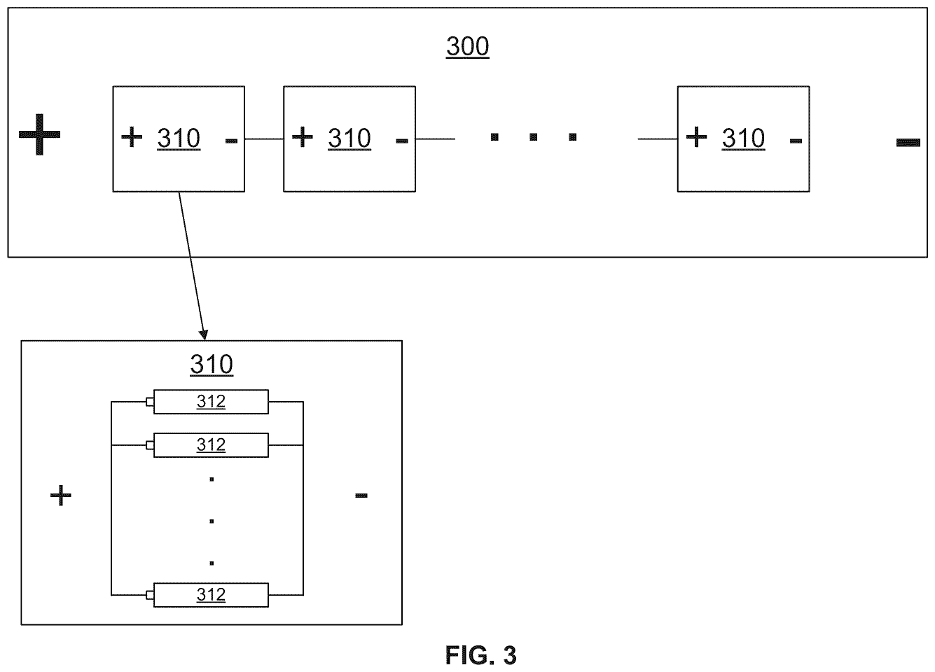

In some embodiments, the one or more first busbars 220, the one or more second busbars 230, the first set of leads, or the second set of leads includes nickel or copper, e.g., nickel-plated copper. Additional details about the busbars 220, 230 and their relationship with the battery cells 210 are further discussed below with respect to FIGS. 2C-2F and 3.

In some embodiments, the battery module 100 also includes a first set of thermally conductive, compressible beads (not shown) aligned with the top surfaces of the battery cells 210, and a second set of thermally conductive, compressible beads aligned with the bottom surface of the battery cells 210. In some embodiments, the thermally conductive, compressible beads are silicon beads. In some embodiments, the thermally conductive, compressible beads include a fire-resistant coating.

In some embodiments, the first thermally conductive plate 110 compresses the first set of thermally conductive compressible beads into the top surfaces of the battery cells through the openings of the first non-conductive layer. The second thermally conductive plate 120 compresses the second set of thermally conductive, compressible beads into the bottom surfaces of the battery cells through the openings of the second non-conductive layer.

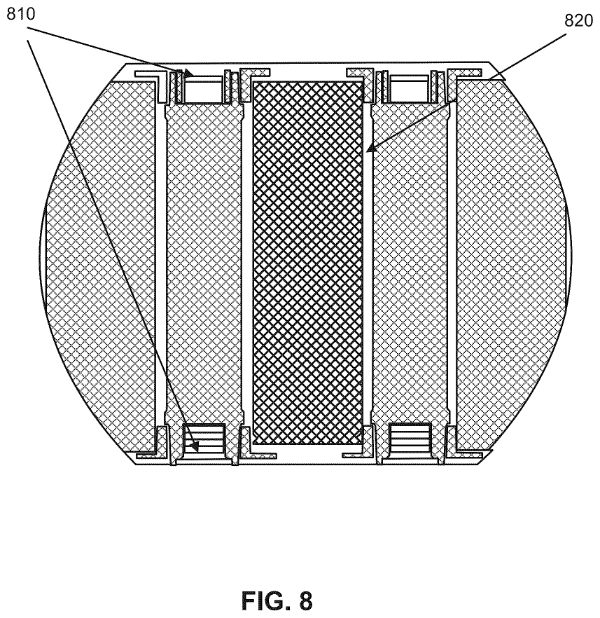

Additional details about the thermally conductive, compressible beads are further described below with respect to FIG. 8.

In some embodiments, the battery module 100 includes a positive potential terminal and a negative potential terminal configured to output a combined voltage of the set of battery cells 210. In some embodiments, the battery module 100 is configured to be connected to one or more additional battery modules via the positive potential terminal and the negative potential terminal. In some embodiments, the battery module is configured to be connected to at least one of the one or more additional battery modules in parallel. In some embodiments, the battery module is configured to be connected to at least one of the one or more additional battery modules in series.

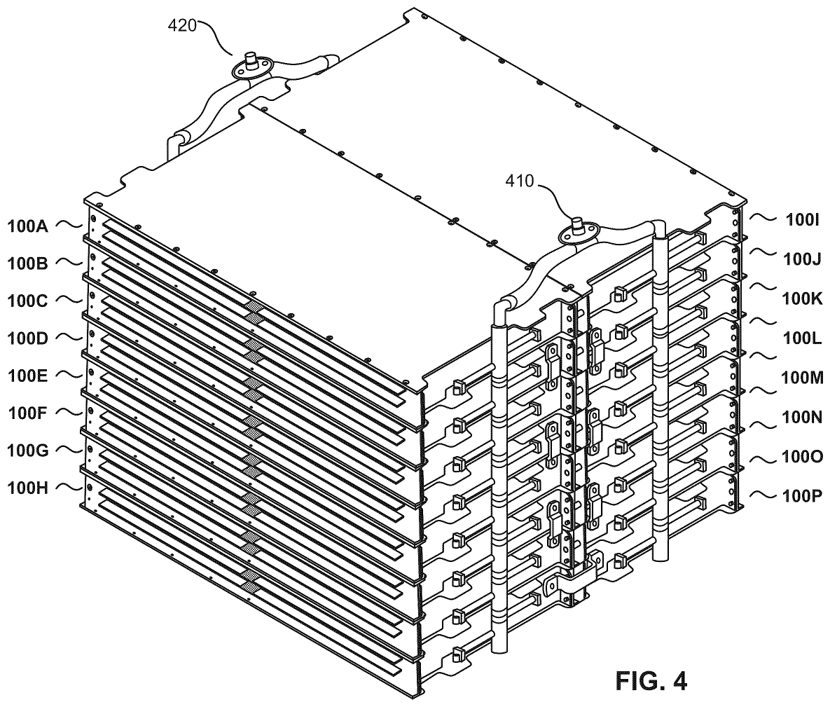

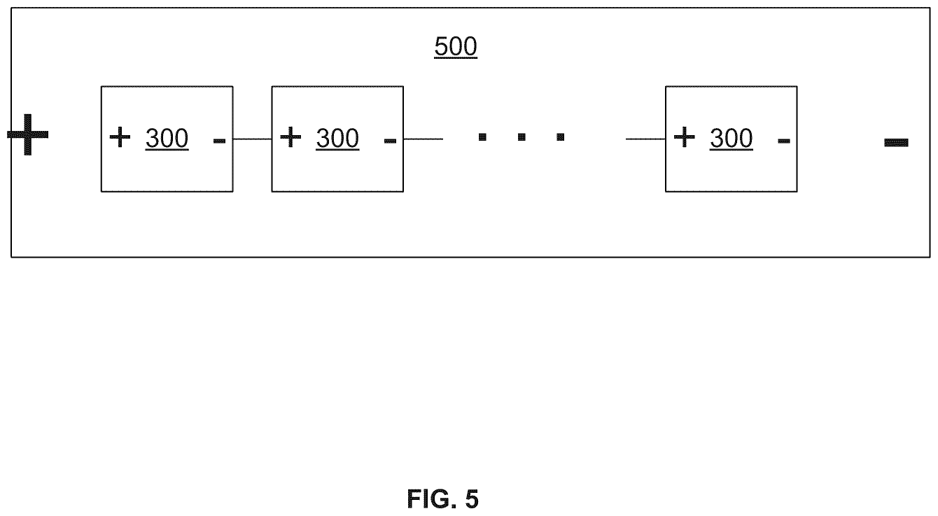

Additional details about forming a battery pack using multiple battery modules 110 are further described below with respect to FIGS. 4-5.

FIG. 2C illustrates an example arrangement of a set of battery cells in accordance with one or more embodiments. The set of battery cells are organized in an array such that top surfaces of the battery cells are substantially coplanar, and bottom surfaces of the battery cells are substantially coplanar. In some embodiments, the set of battery cells are arranged in a honeycomb pattern, such that each battery cell is offset from an adjacent battery cell.

In some embodiments, in the honeycomb pattern, there are 18 battery cells in each row. It is advantageous to include 18 cells in each row. While height is constant due to the cell's nature, there's flexibility in choosing other dimensions. In a honeycomb structure, rows offset and go from 1 to 18. A module with 18 cells has a width of 400 millimeters, which is a half of 800 millimeters, the standard size of many internal combustion engines in smaller machines. Further, multiplying 18 with certain numbers (like 24, 32, or 40) enables optimal serial connections between cells, producing various battery pack voltages (400, 650, or 800 volts). As such, using 18 cells optimizes space and energy density, minimizing overhead.

Note, embodiments described herein are not restricted to any particular number of cells in a row or a column. A battery module can incorporate cells of varying dimensions, arranged in rows and columns of any size. This flexibility in the architecture allows for greater ease and versatility in designing modular battery packs to fit a wide range of applications and requirements. Therefore, embodiments described herein are merely illustrative examples, and should not be considered as limiting the scope of embodiments for the battery module or the overall battery pack.

In some embodiments, the battery module also includes a non-conductive shell abutting a perimeter of the set of battery cells. In some embodiments, the non-conductive shell includes a thermal insulator configured to insulate heat between battery cells and cause heat to leave each battery cell from the top surface or the bottom surface of the battery cell. In some embodiments, the thermal insulator includes polyurethane or epoxy. Additional details about the non-conductive shell are further described below with respect to FIG. 8.

FIG. 2D illustrates an enlarged view of a portion of the busbars in accordance with one or more embodiments. Each busbar includes a frame having a plurality of openings. A lead is connected to an edge of each opening and suspended in each opening. Each lead is configured to electrically connect to an electrode of a battery cell. In some embodiments, each lead includes a battery contact spring. In some embodiments, each lead includes a piece of flexible metal bent towards a corresponding battery terminal. Since all the leads in each busbar are electrically connected to each other, the busbars are configured to connect electrodes of multiple battery cells to form serial or parallel connections. In some embodiments, the busbars or leads include nickel-plated copper. In some embodiments, a thickness of the busbars is from 0.2 millimeters to 0.4 millimeters. In some embodiments, a thickness of the busbars is about 0.3 millimeters.

FIG. 2E illustrates an enlarged view of a portion of non-conductive layers in accordance with one or more embodiments. The one or more non-conductive layers include a thin layer of insulating material, such as plastic. Each non-conductive layer includes a plurality of openings, each of which corresponds to an electrode of a battery cell. Through the openings, the leads on the busbars can be in contact with the electrodes of the battery cells. The role of these non-conductive layers is to keep the battery cells separated from the frames of the busbars. This is essential for safety and functionality because direct contact between the cells and the busbars without a non-conductive layer might cause short circuits or other electrical malfunctions. The non-conductive layers provide an insulating barrier between the active parts of the battery cells and the metallic conductors, preventing unwanted electrical connections.

FIG. 2F illustrates a relationship between the battery cells and the busbars in accordance with one or more embodiments. As illustrated, the battery cells are divided into multiple subsets. Each subset includes a predetermined number of battery cells (e.g., 48 battery cells) arranged in a same direction with their positive potential electrodes all facing upward or downward, while battery cells in adjacent subsets are arranged in opposite directions. As illustrated, there are 12 subsets 210A-210L, each of which includes 48 battery cells. 6 subsets 210A, 210C, 210E, 210G, 210I, 210K include battery cells with their positive potential electrodes facing upward (and their negative potential electrodes facing downward), and the other 6 subsets 210B, 210D, 210F, 210H, 210J, 210L include battery cells with their negative potential electrodes facing upward (and their positive potential electrodes facing downward). In particular, a first subset 210A of battery cells have their positive potential electrodes facing upward, a second subset 210B next to the first subset have their negative potential electrodes facing up, a third subset 210C next to the second subset have their positive electrodes facing up, and so on and so forth.

The subsets of battery cells 210 are electrically connected to each other via battery busbars. As illustrated in FIG. 2F, the battery module has 7 busbars 220A-220G on a first side (e.g., the top side shown in FIG. 2F) and 6 busbars 230A-230F on a second side (e.g., the bottom side shown in FIG. 2F). The first side and the second side are opposing sides of the battery module 100.

On the first side, a first busbar 220A is configured to connect all positive electrodes of the first subset 210A of battery cells, a second busbar 220B is configured to connect all negative electrodes of a second subset 210B of battery cells and all positive electrodes of a third subset 210C of battery cells, a third busbar 220C is configured to connect all negative electrodes of a fourth subset 210D of battery cells and all positive electrodes of a fifth subset 210E of battery cells, a fourth busbar 220D is configured to connect all negative electrodes of a sixth subset 210F of battery cells and all positive electrodes of a seventh subset 210G of battery cells, a fifth busbar 220E is configured to connect all negative electrodes of an eighth subset 210H and all positive electrodes of a ninth subset 210I of battery cells, a sixth busbar 220F is configured to connect all negative electrodes of a tenth subset 210J of battery cells and all positive electrodes of an eleventh subsets 210K of battery cells, and a seventh busbar 220G is configured to connect all negative electrodes of a twelfth subset 210L of battery cells.

On the second side, a first busbar 230A is configured to connect all negative electrodes of the first subset 210A of battery cells and all positive electrodes of the second subset 210B of battery cells, a second busbar 230B is configured to connect all negative electrodes of the third subset 210C of battery cells and all positive electrodes of the fourth subset 210D of battery cells, a third busbar 230C is configured to connect all negative electrodes of the fifth subset 210E of battery cells and all positive electrodes of the sixth subset 210F of battery cells, a fourth busbar 230D is configured to connect all negative electrodes of the seventh subset 210G of battery cells and all positive electrodes of the eighth subset 210F of battery cells, a fifth busbar 230E is configured to connect all negative electrodes of the ninth subset 210I of battery cells and all positive electrodes of the tenth subset 210J of battery cells, and a sixth busbar 230F is configured to connect all negative electrodes of the eleventh subset 210K of battery cells and all positive electrodes of the twelfth subset 210L of battery cells. The subsets 210A-210L of battery cells 210 and the multiple busbars 220A-220G and 230A-230F are configured to connect battery cells 210 in each subset in parallel, and connect multiple subsets in series.

Notably, the embodiments illustrated in the figures are merely example embodiments. There may be any number of battery cells in a subset, and there may be any number of subsets in a battery module, depending on the applications.

FIG. 3 illustrates an example circuit diagram representing the connections of the battery cells in the battery module 100. Each block 310 represents a subset of battery cells, which may correspond to a subset 210A-210L of battery cells of FIG. 2F. Each subset of battery cells 310 includes a predetermined number (N) identical battery cells 312 connected in parallel. Each battery cell 312 may correspond to a battery cell from the set of battery cells 210 of FIG. 2F.

When these battery cells are connected in parallel, a voltage of the subset remains the same as a single battery cell. For example, if each battery cell is a 5 volt (V) battery, the combined voltage for the subset is still 5V. However, the capacity of the subset of battery cells is additive. Since capacity increases in a parallel connection, a maximum deliverable current also increases. This means that each subset of battery cells 310 can provide much more current for a given time compared to a single battery cell. For example, if the subset 310 includes 48 battery cells, each with a capacity of 2000 milliampere-hour (mAh), the total capacity of the subset 310 will be 48×2000 mAh=96000 mAh (or 96 Ah), and the subset 310 will be able to provide 48 times of maximum current compared to a single battery cell. Also, because the subset of battery cells are connected in parallel, an overall internal resistance is effectively reduced. A combined internal resistance can lead to more efficient power delivery, especially under high current draw situations.

Further, as illustrated in FIG. 3, multiple subsets 310 (each includes a same number of battery cells connected in parallel) are connected to each other in series. When multiple subsets 310 are connected in series, a total voltage of the battery module is a sum of the voltages of the individual subset 310. As discussed above, each subset 310 (including battery cells connected in parallel) provides a same voltage as each individual battery cell. Multiple (M) subsets 310 would result in a total voltage of M times the voltage of each individual battery cell. For example, if each individual battery cell is a 5V battery, 12 subsets 310 are connected in series, the combined voltage of the battery module becomes 60 volts.

As described above with respect to FIGS. 1-3, the battery module 100 is highly customizable because it can be customized to have any number of subsets of battery cells connected in serial, wherein each subset can have any number of battery cells connected in parallel.

In addition, depending on the applications, multiple battery modules 100 can also be connected together in parallel, in series, or a combination of both to form a greater battery pack. FIG. 4 illustrates an example battery pack including 16 battery modules 100A-100P connected to each other in series. FIG. 5 illustrates an example circuit diagram representing the connections of the multiple battery modules 300 in a battery pack 400 of FIG. 4 in accordance with one or more embodiments. Each battery module 300 corresponds to the battery module 300 of FIG. 3. As illustrated, multiple battery modules 300 are connected to each other in series. If each battery module 300 can provide a potential of 50 volts, the battery pack including 16 battery modules 300 will be able to provide a potential of 800 volts. Note, FIGS. 4-5 merely illustrate an example embodiment of a battery pack. Different embodiments may be implemented to connect different numbers of battery modules 300 in series, in parallel, or a combination thereof.

The modularity of the embodiments allows EV designers to configure a battery pack as per their voltage and capacity requirements by arranging modules in series or parallel and to fit specific spatial or capacity requirements. Further, if one module fails, it can be replaced without having to replace the entire battery pack. This can lead to cost savings and reduced downtime. In addition, in case of a malfunction or damage to a specific module, the affected module can be isolated and removed. This also limits the spread of potential issues to other modules or components. In some embodiments, individual modules can be charged separately based on their state of charge, which can lead to faster and more efficient charging overall. Further, since each module has its own cooling plates, heat is more evenly distributed, reducing the risk of overheating and potentially extending the battery's lifespan.

### Cooling System Architecture

The embodiments described herein also include a battery module cooling system. Referring back to FIG. 1, the battery module cooling system described herein includes two cooling plates (also referred to a first cooling plate and a second cooling plate) on top and bottom sides of the battery module 100. The first cooling plate is thermally coupled to a top surface of the battery module, and the second cooling plate is thermally coupled to a bottom surface of the battery module. In some embodiments, the first cooling plate and the second cooling plate are similar, and the cooling plates are structurally strong enough to provide mechanical support for the battery module. In some embodiments, each of the first cooling plate 110 or the second cooling plate 120 includes two metal sheets (e.g., aluminum sheets) with fluid channels carved therein.

The first cooling plate 110 includes a first fluid inlet channel and a first fluid outlet channel. The first fluid inlet channel feeds each of a first plurality of sets of fluid channels that each feed the first fluid outlet channel. The first plurality of sets of fluid channels are arranged such that a hottest portion of a first fluid channel is adjacent to a coolest portion of a second fluid channel. Similarly, the second cooling plate 120 includes a second fluid inlet channel and a second fluid outlet channel. The second fluid inlet channel feeds each of a second plurality of sets of fluid channels that each feed the second fluid outlet channel. The second plurality of sets of fluid channels are arranged such that a hottest portion of a third fluid channel is adjacent to a coolest portion of a fourth fluid channel. Further, the hottest portion of the first fluid channel of the first cooling plate and the coolest portion of the fourth fluid channel of the second cooling plate are thermally coupled to a same subset of battery cells (e.g., such that a top surface of the subset of battery cells is thermally coupled to the hottest portion of the first fluid channel and such that a bottom surface of the subset of battery cells is thermally coupled to the coolest portion of the fourth fluid channel).

FIG. 6 illustrates an example embodiment of a cooling plate 600 corresponding to the first cooling plate 110 or the second cooling plate 120. The cooling plate 600 includes a flat metal plate or other thermally conductive material and is coupled to the busbars 220, 230 of the battery module 100. In some embodiments, the cooling plate is formed by attaching two metal sheets together, where the two metal sheets have channels 630 carved therein. In some embodiments, the metal sheets are aluminum sheets. In some embodiments, a thickness of each metal sheet ranges from 1 to 3 millimeters. In some embodiments, a thickness of each metal sheet ranges from 1.5 to 2.5 millimeters. In some embodiments, a thickness of each metal sheet is approximately 2 millimeters, resulting in a total cooling plate thickness of approximately 4 millimeters.

As illustrated, the cooling plate 600 includes a fluid inlet channel 610 and a fluid outlet channel 620. The fluid inlet channel 610 feeds each of a plurality of sets of fluid channels 630 that each feed the fluid outlet channel 620. The plurality of sets of fluid channels 630 are arranged such that a hottest portion of a first fluid channel 630A (the end portion of the first fluid channel 630A immediately before the fluid outlet channel 620) is adjacent to a coolest portion of a second fluid channel 630B (the beginning portion of the second fluid channel 630B immediately after the fluid inlet channel 610). As used herein, the “hottest portion” of a fluid channel refers to a portion of a fluid channel through which a hottest portion of fluid (fluid that has been heated as it passes through earlier portions of the fluid channel) passes. Likewise, as used herein, the “coolest portion” of a fluid channel refers to a portion of a fluid channel through which a coolest portion of fluid (fluid that has not been significantly heated as it passes through the fluid channel, since the fluid has not yet passed through a significant portion of the fluid channel). In some embodiments, each of the plurality of sets of fluid channels (or each portion of the fluid channels) corresponds to a row of battery cells.

FIG. 7 illustrates an example embodiment of a perspective view of an aligned top cooling plate 700A and a bottom cooling plate 700B that overlap each other. The top cooling plate 700A and the bottom cooling plate 700B may correspond to the first and second cooling plates 110 and 120 of FIG. 1. The top cooling plate 700A includes a first inlet 710A, a first outlet 720A, and one or more first channels 730A connecting the first inlet 710A and the first outlet 720A. The bottom cooling plate 700B includes a second inlet 710B, a second outlet 720B, and one or more second channels 730B connecting the second inlet and the second outlet. The first inlet 710A is at a first edge (e.g., left side) of the top cooling plate 700A, and the first outlet 720A is at a second edge (e.g., right side) of the top cooling plate opposite to the first edge. The second inlet 710B is at the first edge (e.g., left side) of the bottom cooling plate 700B, and the second outlet 720B is at the second edge (e.g., right side) of the bottom cooling plate 700B. The first channels 730A and the second channels 730B at least partially overlap each other.

In particular, the hottest portion (represented by solid arrow lines) of the fluid channel of the first cooling plate 700A and the coolest portion (represented by dashed arrow lines) of the fluid channel of the second cooling plate 700B are thermally coupled to a same subset of battery cells (e.g., the hottest portion of the fluid channel of the first cooling plate thermally abuts the top of the subset of battery cells and the coolest portion of the fluid channel of the second cooling plate thermally abuts the bottom of the subset of batter cells). The arrangement of the top and bottom cooling plates 700A, 700B further promotes equal temperature distribution across the module.

In some embodiments, the first fluid inlet channel 710A and the second fluid inlet channel 710B are at a first side (e.g., left side) of the cooling system, and the first outlet channel 720A and the second fluid outlet channel 720B are at a second side (e.g., right side) of the battery module cooling system opposite from the first side. In some embodiments, a same fluid source is coupled to both the first fluid inlet 710A and the second fluid inlet 710B, and a same fluid sink is coupled to both the first fluid outlet 720A and the second fluid outlet 720B.

It is advantageous to place all the inlets on a same side of the cooling system, and all the outlets on a same edge of the cooling system, such that when multiple battery modules are connected together, not only the positive or negative terminals can be connected together, the inlets and outlets of the multiple cooling systems can also be connected together.

In some embodiments, the battery module cooling system is configured to be connected to one or more additional battery module cooling systems, causing at least one of the first fluid inlet channel or second fluid inlet channel to be connected to at least one inlet of the one or more additional battery modules. In some embodiments, the battery module cooling system is configured to stack on top of or be stacked upon by at least one of the one or more additional battery modules to form a pack with all inlets on a first side of the pack and all outlets on a second side of the pack opposite from the first side of the pack. In some embodiments, the battery module cooling system is configured to be aligned next to at least one of the one or more additional battery modules to form a pack with all inlets on a first side of the pack, and all outlets on a second side of the pack opposite from the first side of the pack.

Referring back to FIG. 4, there are twelve battery modules interconnected to each other to form a battery pack. The inlets of all the battery modules are on a first side of the battery pack and connected to each other, and the outlets of all the battery modules are on a second side of the battery pack and are connected to each other. A single inlet 410 and a single outlet 420 are formed at the top of the battery pack. They are designed to channel fluid from a single fluid source to the inlets of every battery module in the pack and to funnel fluid from the outlets of each module to a singular fluid sink.

FIG. 8 illustrates a cross-sectional view of a portion of the battery module in accordance with one or more embodiments. The portion of the battery module includes two battery cells. A cooling plate is placed at the top and bottom of the battery cells. There is thermally conductive layer 810 on each top and bottom side of the battery cells. The thermal thermally conductive layer 810 functions as an interface between the battery cells and the cooling plates. In some embodiments, a distance between the top or bottom side of the battery cells to the cooling plate is between 2 to 3 millimeters. In some embodiments, the distance between the top and bottom side of the battery cells to the cooling plate is between 2.4 and 2.6 millimeters. In some embodiments, the distance between the top and bottom side of the battery cells to the cooling pate is approximately 2.5 millimeters.

In some embodiments, the thermally conductive layer 810 includes a set of thermally conductive, compressible beads, e.g., silicon beads. In some embodiments, the set of thermally conductive, compressible beads include a fire-resistant coating. In some embodiments, thermally conductive beads are injected on each side of the battery cells before the cooling plates are mounted. In some embodiments, the thermally conductive beads are flexible, and the cooling plates are configured to slightly compress the beads to ensure direct thermal contact between the beads and the cells and the cooling plates.

Further, in some embodiments space between cells is filled with a thermal insulator 820 to form a thermally non-conductive shell, such that the sidewalls of each battery cell are thermally insulated from the outside to push heat to leave the cell from the top and bottom sides. In some embodiments, the thermal non-conductive shell is further configured to encase the cells for consistent cell positioning. In some embodiments, a distance between adjacent cells is about 1.5 millimeters in every direction. In some embodiments, the thermal insulating shell not only provides thermal insulation, but also provides structural integrity, and fire prevention.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of symbolic representations of operations on information. These representations are commonly used by those skilled in the arts to convey the substance of their work effectively to others skilled in the art. These operations, while described functionally, or logically, are understood to be implemented by mechanical or electrical components, or the like. Furthermore, it has also proven convenient at times, to refer to these arrangements of operations as modules, without loss of generality. The described operations and their associated modules may be embodied in mechanical components, devices, or any combinations thereof.

Any of the steps, operations, or processes described herein may be performed or implemented with one or more mechanical or electrical modules, alone or in combination with other devices.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A battery module cooling system, comprising:
a first cooling plate thermally coupled to a top surface of an array of battery cells, the first cooling plate comprising a first fluid inlet channel and a first fluid outlet channel, the first fluid inlet channel feeding each of a first plurality of sets of fluid channels that each feed the first fluid outlet channel, the first plurality of sets of fluid channels arranged such that a hottest portion of a first fluid channel is adjacent to a coolest portion of a second fluid channel; and
a second cooling plate thermally coupled to a bottom surface of an array of battery cells, the second cooling plate comprising a second fluid inlet channel and a second fluid outlet channel, the second fluid inlet channel feeding each of a second plurality of sets of fluid channels that each feed the second fluid outlet channel, the second plurality of sets of fluid channels arranged such that a hottest portion of a third fluid channel is adjacent to a coolest portion of a fourth fluid channel,
wherein the hottest portion of the first fluid channel of the first cooling plate and the coolest portion of the fourth fluid channel of the second cooling plate are thermally coupled to a same subset of battery cells.

2. The battery module cooling system of claim 1, wherein each fluid channel of the first plurality of sets of fluid channels or the second plurality of sets of fluid channels corresponds to a row of battery cells.

3. The battery module cooling system of claim 1, wherein each of the first cooling plate or the second cooling plate comprises two metal sheets with fluid channels carved therein.

4. The battery module cooling system of claim 3, wherein the two metal sheets comprise aluminum.

5. The battery module cooling system of claim 3, wherein a thickness of each metal sheet ranges from 1.5 to 2.5 millimeters.

6. The battery module cooling system of claim 1, wherein the first fluid inlet channel and the second fluid inlet channel are positioned at a first side of the battery module cooling system, and
the first outlet fluid channel and the second outlet fluid channel are positioned at a second side of the battery module cooling system, opposite from the first side.

7. The battery module cooling system of claim 1, wherein a same fluid source is coupled to both the first fluid inlet and the second fluid inlet, and wherein a same fluid sink is coupled to both the first fluid outlet and the second fluid outlet.

8. The battery module cooling system of claim 1, further comprising a thermal insulating shell encasing each of the array of battery cells, the thermal insulating shell configured to cause heat to leave the array of battery cells from the top surface or the bottom surface of the array of battery cells.

9. The battery module cooling system of claim 8, wherein the thermal insulating shell comprises polyurethane or epoxy.

10. The battery module cooling system of claim 1, further comprising:
a first thermally conductive layer between the first cooling plate and the top surface of the array of battery cells configured to conduct heat from the top surface of the array of battery cells to the first cooling plate, and
a second thermally conductive layer between the second cooling plate and the bottom surface of the array of battery cells configured to conduct heat from the bottom surface of the array of battery cells to the second cooling plate.

11. The battery module cooling system of claim 10, wherein the first thermally conductive layer comprises a first set of thermally conductive, compressible beads,
the first cooling plate compresses the first set of thermally conductive, compressible beads into the top surface of the array of battery cells,
the second thermally conductive layer comprises a second set of thermally conductive, compressible beads, and
the second cooling plate compresses the second set of thermally conductive, compressible beads into the bottom surface of the array of battery cells.

12. The battery module cooling system of claim 11, wherein the first or second set of thermally conductive, compressible beads comprise silicon beads.

13. The battery module cooling system of claim 11, wherein the first or second set of thermally conductive, compressible beads comprise a fire-resistant coating.

14. The battery module cooling system of claim 1, wherein the first or second cooling plate is also configured to structurally support the array of battery cells.

15. The battery module cooling system of claim 1, wherein the battery module cooling system is configured to be connected to one or more additional battery module cooling systems, causing at least one of the first fluid inlet channel or second fluid inlet channel to be connected to at least one inlet of the one or more additional battery modules.

16. The battery module cooling system of claim 15, wherein the battery module cooling system is configured to stack on top of or be stacked upon by at least one of the one or more additional battery modules to form a pack with all inlets on a first side of the stack, and all outlets on a second side of the pack opposite from the first side of the pack.

17. The battery module cooling system of claim 16, wherein the battery module cooling system is configured to be aligned next to at least one of the one or more additional battery modules to form a pack with all inlets on a first side of the pack, and all outlets on a second side of the pack opposite from the first side of the pack.
